(19) United States
(12) Patent Application Publication
(10) Pub. No.: US 2004/0153364 A1
(43) Pub. Date: Aug. 5, 2004

(54) Information presentation system and information presentation method

(76) Inventor: Shigeyasu Natsubori, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/626,637

(22) Filed: Jul. 25, 2003

Related U.S. Application Data
(63) Continuation of application No. PCT/JP01/00548, filed on Jan. 26, 2001.

(51) Int. Cl. G06F 17/60

(52) U.S. Cl. 705/14

(57) ABSTRACT

In an information presentation system which presents a commercial of a sponsor by inserting the commercial into a program which a broadcasting company provides, a bid processing section acquiring a bid price from the sponsor in a prior period which is before the program by the broadcasting company starts, a bid control section determining a successful bidder on the basis of a reference which is set in advance from the bid price acquired by the data presenting condition acquiring means, and a notifying section notifying the broadcasting company of notification data corresponding to the successful bidder determined by the control section, are provided.

### CROSS-REFERENCE TO RELATED APPLICATIONS

This is a Continuation Application of PCT Application No. PCT/JP01/00548, filed Jan. 26, 2001, which was not published under PCT Article 21(2) in English.

### BACKGROUND OF THE INVENTION

1. Field of the Invention

The present invention relates to an information presentation system and an information presentation method for determining an advertisement fee of a commercial which is inserted into a broadcast program or the like, in accordance with bids of sponsors.

2. Description of the Related Art

Presentation of a broadcast program in a television broadcast is carried out by sponsors of commercials which are broadcast during a broadcast program, and the revenues of a broadcasting company such as a broadcasting station or the like is mainly the advertising fees which sponsors pay. Such an advertisement fee of a commercial is generally set by mutual consent between the broadcasting station and the sponsor on the basis of a predetermined reference, referring to a broadcasting time slot and the past audience rating.

However, there are cases in which the determination of the advertisement fee by a uniform reference is unreasonable due to the following reasons. Namely, because the audience rating of a sports broadcast or the like markedly varies in accordance with the development thereof, when the audience rating is lower than the estimate, the sponsor cannot acquire an advertising effect corresponding to the advertisement fee. On the other hand, there may be cases in which the audience rating becomes higher than the estimate, and the advertising effect becomes extremely high.

Further, when an unexpected incident/accident arises, there are cases in which the audience rating of a news program or the like becomes high even though it is early morning/late night, and there is the concern that the broadcasting station will lose an opportunity for obtaining a high advertisement fee. In this way, there is the problem that the advertisement fee is determined by a uniform reference regardless of the fact there are variable factors in the audience rating.

On the other hand, digital recording equipment which can carry out recording by a digital system become popular. In accordance therewith, when the audience views a broadcast program recorded by digital recording equipment, random access to the program is possible, and the audience can instantly skip the commercials. Namely, it is possible for the audience to view the broadcast program without viewing the commercials at all, and the problem that the advertising effect by the commercials cannot be obtained, arises. Therefore, there is the problem that presentation of broadcast programs or the like by sponsors becomes passive, and the revenues of a broadcasting stations or the like decrease.

Note that it can be thought that the problems of the advertisement fees of commercials and skipping of commercials as described above are not limited to television broadcasting, and arise in Internet broadcasting as well in the same way.

Thus, an object of the present invention is to provide an information presentation system and an information presentation method which can appropriately determine an advertisement fee of a commercial accompanying a broadcast program or the like, and which can maintain the advertising effect of the commercial.

### BRIEF SUMMARY OF THE INVENTION

The present invention is an information presentation system which inserts presented data of a data presentation client into provided data which a service provider provides, and which presents the presented data, the information presentation system comprising: data presenting condition acquiring means for acquiring data presenting conditions from the data presentation client in a prior period which is before a providing period of the provided data by the service provider starts; data presenting condition determining means for determining data presenting conditions on the basis of a reference which is set in advance from the data presenting conditions acquired from the data presenting condition acquiring means, after the prior period passes; and notifying means for notifying the service provider of notification data corresponding to the data presenting conditions determined by the data presenting condition determining means.

As a result, in accordance with the present invention, the advertisement fee of a commercial accompanying a broadcast program or the like can be appropriately determined, and the advertising effect of the commercial can be maintained.

### BRIEF DESCRIPTION OF THE SEVERAL VIEWS OF THE DRAWING

FIG. 1 is a diagram showing a configuration of an information presentation system according to a first embodiment of the present invention.

FIG. 2 is a flowchart showing an example of operations of the information presentation system.

FIGS. 3A and 3B are explanatory diagrams showing timing charts in accordance with the information presentation system.

FIGS. 4A and 4B are explanatory diagrams showing display examples in accordance with the information presentation system.

FIGS. 5A, 5B, and 5C are explanatory diagrams showing display examples in accordance with the information presentation system.

### DETAILED DESCRIPTION OF THE INVENTION

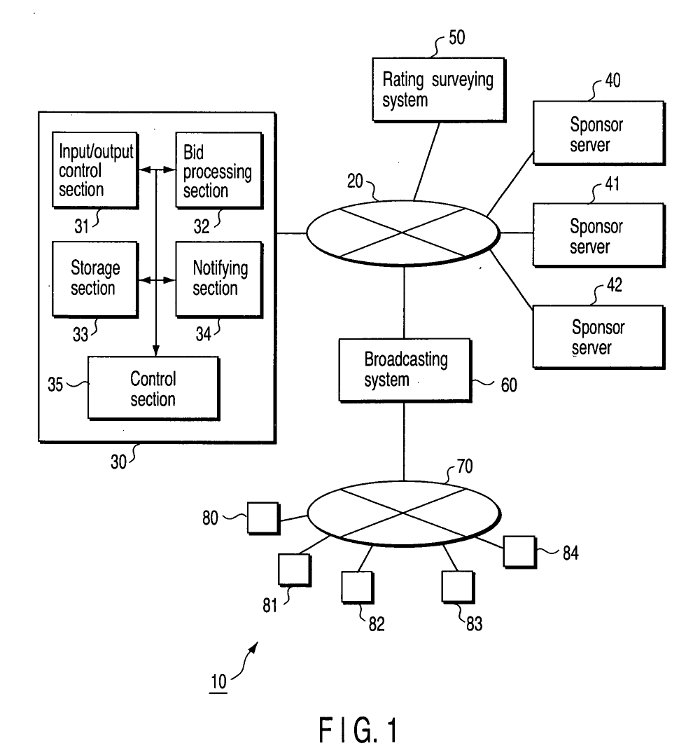

Hereinafter, an embodiment of the present invention will be described with reference to the drawings. An information presentation system 10 is a system in which commercial data (presented data) of a sponsor (data presentation client) is inserted into a program (provided data) which a television broadcasting company (service provider) provides, and is presented. As shown in FIG. 1, the information presentation system 10 is connected to a communication line 20 such as the internet or the like, a management server 30 connected to the communication line 20, sponsor servers 40 to 42 connected to the communication line 20, a rating surveying system 50 connected to the communication line 20, and a broadcasting system 60 connected to the communication line 20. The broadcasting system 60 is further connected to television receivers 80 to 85 of respective audiences via a communication/broadcasting network 70.

The management server 30 is managed by a data selecting company, and has an input/output control section 31 for carrying out input/output of data, a bid processing section 32 for receiving the bid data transmitted from the respective sponsors, a storage section 33 for storing respective data such as a program schedule, an audience rating, or the like, a notifying section 34 for reporting the results of the bidding, and a control section 35 for relatedly controlling them in accordance with a predetermined program. The management server 30 has the functions of transmitting to the sponsor servers 40 to 42 various data such as the information relating to a broadcast program, the audience rating information, and the like, and of receiving various data such as the bid prices of the sponsor servers 40 to 42, or the like, and of carrying out determining of a commercial inserted in the broadcast program.

The sponsor servers 40 to 42 are managed by sponsors carrying out selling of various commercial products, services, or the like. An inputting device such as a monitor, a keyboard, or the like, and a selling system are provided thereat. The sponsor servers 40 to 42 have the function of carrying out inputting of a bid price or the like, and the function of receiving order data from the audience and carrying out selling of the commercial products, on the basis of data transmitted from the management server 30.

The rating surveying system 50 is managed by a rating surveying company, and has the functions of computing the audience rating by using a rating surveying device attached to each television receiver or the like, the function of transmitting the data to the management server 30.

The broadcasting system 60 is managed by a television broadcasting company, and transmits broadcast programs and commercials at predetermined times, and the commercial data is stored therein. The broadcasting system 60 has the functions of broadcasting programs in accordance with a program schedule, and of carrying out insertion of commercials on the basis of notification data transmitted from the management server 30.

The communication/broadcasting network 70 is, for example, a broadcasting network by ground waves or satellite waves, cable television, an interactive communication network, or the like. The communication/broadcasting network 70 has the functions of conveying the broadcasting data from the broadcasting system 60 to the television receivers 80 to 85, and of conveying order data from the television receivers 80 to 85 to the broadcasting system 60.

The television receivers 80 to 85 include an input device such as a remote controller, a touch panel, a keyboard, or the like, and have the function of transmitting order data to the broadcasting system 60 side via the communication/broadcasting network 70.

In the information presentation system 10 configured in this way, insertion of a commercial into a predetermined program is carried out as follows. Note that the program is constituted of a plurality of program sections (program slots) S1 to Sn, and commercials C1 to Cn are respectively inserted into the program sections S1 to Sn.

In the management server 30, broadcast basic data such as a broadcast program planning schedule, past audience rating information, and the like are distributed in advance to the sponsor servers 40 to 42 via the communication line 20. Further, with respect to the latest audience rating information, the latest audience rating information which the management server 30 acquired from the rating surveying system 50 are successively transmitted to the sponsor servers 40 to 42. On the other hand, the sponsors transmit the commercial data in advance to the broadcasting system 60 by using the sponsor servers 40 to 42 or another method, and in the broadcasting system 60, the commercial data are stored in the storage section. Note that it is supposed that the time, the contents, and the like of the commercial data are checked in advanced, and given standards as a commercial are satisfied.

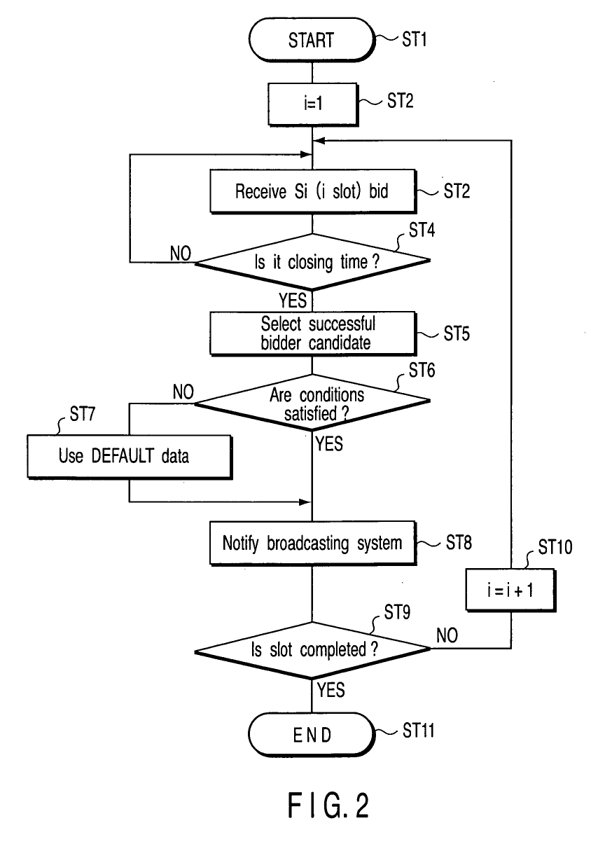

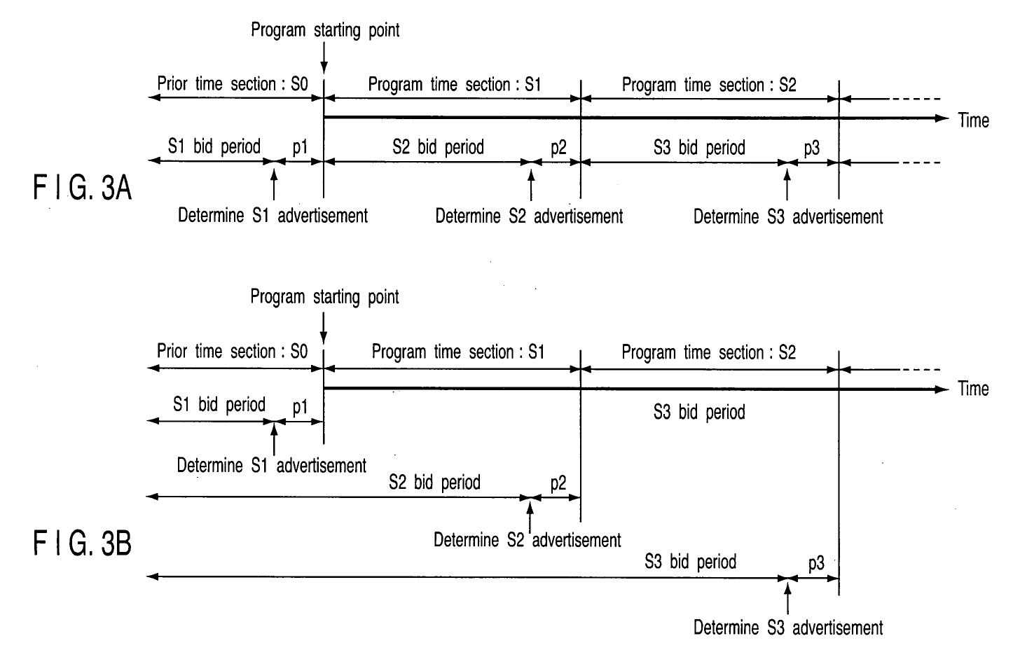

Next, an example of the operations of the information system will be described with reference to FIGS. 2 and 3. When the broadcasting time of the program draws near, a predetermined prior section S0 is set, and bidding starts as shown in FIG. 2 (ST1). In the management server 30, an initial value 1 is set in order to carry out bidding for the program section S1 first (ST2). The sponsors determine the bid prices on the basis of the broadcast basic data and the audience rating, and transmit the bid prices to the management server 30 via the sponsor servers 40 to 42.

In the management server 30, the bid prices from the sponsor servers 40 to 42 are received (ST3), and the receipt is completed at the point in time when the time reaches before a preparatory time P1 (ST4) of the program section S1, and the sponsor who tendered the highest price is selected as a successful bidder candidate (ST5). Note that a bidding coefficient may be calculated by comprehensively deciding the conditions relating to the bid such as the past bid results, and the bid price may be corrected due to the bidding coefficient being multiplied by the bid price, and the corrected price may be made to be the bid price.

Next, it is decided whether or not the conditions, which are determined by the broadcasting system 60 in advance from the commercial data or the like of the sponsor who is the successful bidder candidate, are satisfied (ST6). As the conditions, for example, there are conditions such as the bid price of the commercial exceeds the minimum bid price, the commercial suits the program contents, the same sponsor is not continuously determined, or the like. When the conditions are not satisfied, this fact is notified to the sponsor, and commercial data which has been set in advance, or the like, is used (ST7). In addition, it is possible for the commercial data not to be inserted in the program.

Subsequently, the determined sponsor is notified as notification data to the broadcasting system 60 (ST8), and it is decided whether the entire program section has been completed or not (ST9). When the entire program section has not been completed, it is increased by one (ST10), and the routine returns to ST2.

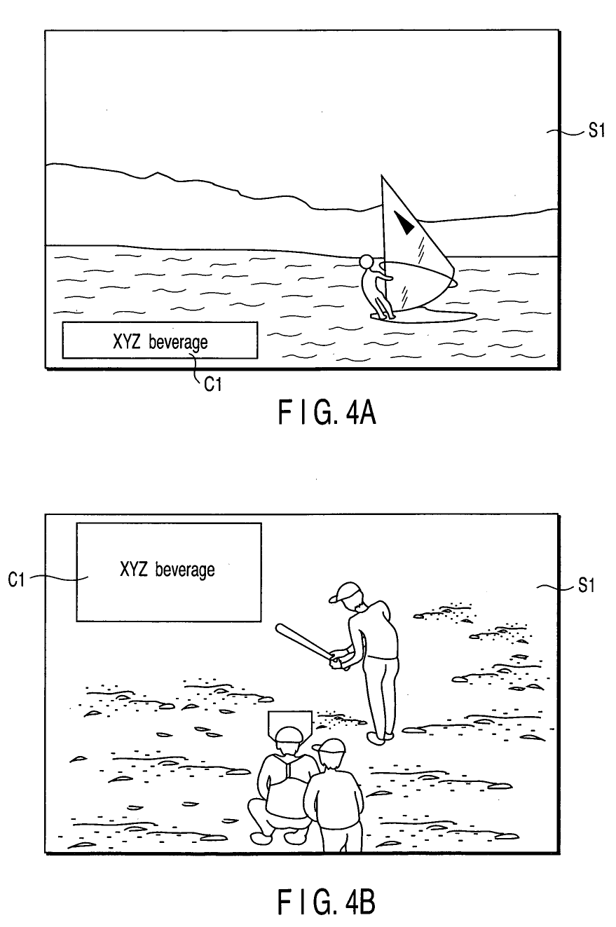

Note that, in the broadcasting system 60, the commercial data corresponding to the sponsor in the notification data is called-up from the storage section, and the commercial C1 is superimposed on the program contents set in the program section S1, and broadcasting is carried out. FIGS. 4A and 4B are diagrams showing concrete examples shown on the television receivers 80 to 85.

In addition, the commercial data is inserted into one portion in the main stream, for example, the lower corner, or the left and right sides of the screen (using the margin portions when a 4:3 image is used on a 16:9 monitor). Note that the commercial data may be displayed on the entire screen at an appropriate timing.

In the same way, the bids are repeatedly carried out until it comes to the program section Sn, and the routine is completed at the point in time when all of the sections are completed (ST11).

On the other hand, it is possible for the audience to transmit the order data to the sponsor servers 40 to 42 due to selection by clicking or the like the commercial data C1, C2 displayed on the television receivers 80 to 85. Note that, in the sponsor servers 40 to 42, shipping of the commercial product to the audience is carried out on the basis of the order data.

Note that, in FIGS. 2 and 3A, a bid for the next program section cannot be carried out until a bid for one program section is completed. However, as shown in FIG. 3B, the bid receipts of all program sections S1 to Sn may start simultaneously.

As described above, in accordance with the information presentation system 10, an advertisement fee can be determined by bidding in accordance with program contents. Therefore, even when the audience rating markedly varies in accordance with the development as in a sports relay broadcast or the like, or even in a late night/early morning news program or the like in a case in which the audience rating rises when an unexpected incident arises, the advertisement fee can be determined by bidding of the sponsors.

Accordingly, the revenues of the broadcasting company can be increased, and it is possible for the sponsors to place advertisements in accordance with the advertising effects.

Further, because the commercial data is displayed so as to be superimposed on the program, even when digital recording equipment is used, it is possible to avoid a state in which the commercial is not viewed by the audience.

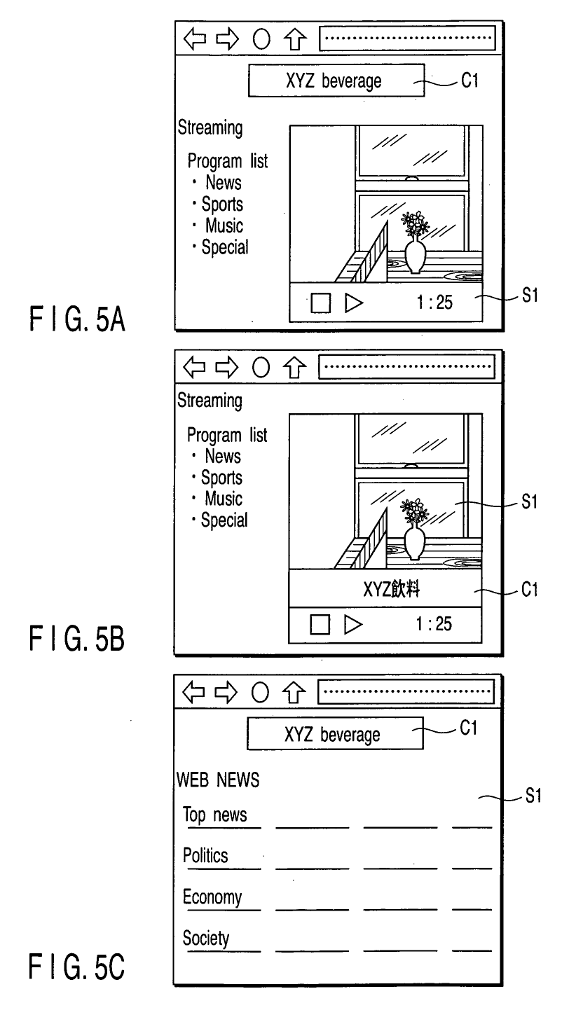

FIGS. 5A to 5C are views showing cases in which the information presentation system 10 is applied to information presentation by the internet. FIG. 5A is an example in which a commercial is simultaneously displayed on a display by using scene description language such as SMIL or the like, and FIG. 5B is an example in which the commercial data is superimposed on one portion of a streaming broadcast. Further, FIG. 5C is an example in which the present invention is applied to a banner advertisement inserted into a news site. Even in this case, it is possible for a sponsor to request an advertisement in consideration of the advertising effects from the broadcast program contents, the news contents, and the like. Note that, when a banner advertisement is inserted, it is preferable for the period for replacing the banner advertisement to be set so as to be long to some extent (for example, such as morning, afternoon, and night).

Note that the present invention is not limited to the above-described embodiment. Namely, in the embodiment described above, the commercial is inserted by being superimposed on each program. However, the present invention may be a usual commercial insertion method in which a commercial is inserted between one program section and another program section.

Further, cable television, an interactive communication network, or the like which can interactively communicate is illustrated as the communication/broadcasting network 70. However, if the communication/broadcasting network 70 is a one-way communication method, such as a television broadcast or the like, an order from the audience to the sponsor may be carried out by using another means, such as telephone, facsimile, or the like.

Moreover, the commercial data is stored in advance in the broadcasting system 60. However, the commercial data may be transmitted from the sponsor servers 40 to 42 to the broadcasting system 60 at the point in time when a sponsor is determined.

Further, even when all advertisement fees have been determined in advance in a series program such as a TV drama, and the contract with the sponsor is completed, this method is applicable. Namely, the sponsor presents an advertisement fee allocated for each time or each slot among all of the advertisement fees which have been contracted in advance, and bidding is carried out on the basis thereof, and a successful bidder is determined.

Moreover, a sponsor carrying out bidding relating to an advertisement may be selected in advance in accordance with a reference separately determined for each program which is a bidding object. Namely, depending on the program, there are cases in which the sponsors are limited to several sponsors. However, on the other hand, there are cases in which, provided that a sponsor is a sponsor who can utilize the system, the sponsor can freely participate. Further, a method can be used in which, when a sponsor who bid is selected, the sponsor pays a given advertisement fee, and an advertisement within the range of a reference separately determined in accordance with the advertisement fee is broadcast.

In addition, it goes without saying that various modifications and applications are possible within a range which does not deviate from the gist of the present invention.

The present invention is useful for the technical field of an information presentation system which is useful for appropriately determining an advertisement fee at a broadcasting company, an internet provider, or the like.

What is claimed is:

1. An information presentation system which inserts presented data of a data presentation client into provided data which a service provider provides, and which presents the presented data, the information presentation system comprising:
data presenting condition acquiring means for acquiring data presenting conditions from the data presentation client in a prior period which is before a providing period of the provided data by the service provider starts;
data presenting condition determining means for determining data presenting conditions on the basis of a reference which is set in advance from the data presenting conditions acquired from the data presenting condition acquiring means, after the prior period passes; and
notifying means for notifying the service provider of notification data corresponding to the data presenting conditions determined by the data presenting condition determining means.

2. An information presentation system according to claim 1, wherein the data presenting conditions are bid prices which the data presentation clients pay to the service provider, and
the data presenting condition acquiring means has bid price acquiring means for acquiring the bid prices.

3. An information presentation system according to claim 2, wherein the data presenting condition determining means determines data presenting conditions corresponding to a maximum price among the bid prices.

4. An information presentation system according to claim 2, wherein the data presenting condition determining means determines data presenting conditions by comprehensively deciding all conditions relating to the bidding which are the bid prices among the bidders and past bid results.

5. An information presentation system according to claim 1, wherein, when the data presenting conditions are not determined by the data presenting condition determining means, the notifying means reports notification data including this fact.

6. An information presentation system according to claim 5, wherein, when the notification data is reported to the service provider, the service provider does not insert the presented data into the provided data, or inserts presented data which has been determined in advance into the provided data.

7. An information presentation system according to claim 1, wherein the presented data and the provided data are two dimensional data respectively structured from images, characters, and the like, and
the service provider provides an image of the presented data and an image of the provided data so as to be superimposed on each other.

8. An information presentation system according to claim 1, wherein the presented data is data including at least an image, and
the providing period of the provided data is divided into a plurality of sections, and the presented data is inserted between these plurality of sections.

9. An information presentation method of inserting presented data of a data presentation client into provided data which a service provider provides, and presenting the presented data, the information presentation method comprising:
a data presenting condition acquiring step of acquiring data presenting conditions from the data presentation client in a prior period which is before a providing period of the provided data by the service provider starts;
a data presenting condition determining step of determining data presenting conditions on the basis of a reference which is set in advance from the data presenting conditions acquired from the data presenting condition acquiring step, after the prior period passes; and
a notifying step of notifying the service provider of notification data corresponding to the data presenting conditions determined by the data presenting condition determining step.

10. An information presentation system which inserts presented data of a data presentation client into provided data which a service provider provides, and presents the presented data, the information presentation system comprising:
data presenting condition transmitting means for transmitting data presenting conditions by the data presentation client;
data presenting condition acquiring means for acquiring data presenting conditions from the data presentation client in a prior period which is before a providing period of the provided data by the service provider starts;
data presenting condition determining means for determining data presenting conditions on the basis of a reference which is set in advance from the data presenting conditions acquired from the data presenting condition acquiring means, after the prior period passes;
notifying means for reporting notification data corresponding to the data presenting conditions determined by the data presenting condition determining means; and
providing means for providing the presented data by inserting the presented data into the provided data on the basis of the notification data from the notifying means.
